(19) United States
(12) Patent Application Publication
(10) Pub. No.: US 2012/0313904 A1
(43) Pub. Date: Dec. 13, 2012

(54) DISPLAY APPARATUS AND DISPLAY DRIVING METHOD THEREOF

(76) Inventor: Tsang-Hong Wang, Hsin-Chu (TW)

(21) Appl. No.: 13/293,140

(22) Filed: Nov. 10, 2011

(30) Foreign Application Priority Data
Jun. 7, 2011 (TW) 100119760

(51) Int. Cl. G06F 3/038

(52) U.S. Cl. 345/204

(57) ABSTRACT

A display apparatus capable of enhancing pixel charging rate includes a substrate, a first column transmission line for transmitting a first column driving signal, a second column transmission line for transmitting a second column driving signal, and a row transmission line for transmitting a row driving signal. The substrate has plural row wiring areas and plural column wiring areas. The row and column wiring areas, substantially perpendicular to each other, are isolated by an insulation layer. The first and second column transmission lines, electrically isolated from each other, are disposed in one and the same column wiring area. The row transmission line is disposed in a corresponding row wiring area.

### BACKGROUND

1. Technical Field

The disclosure relates to a display apparatus, and more particularly, to a display apparatus capable of enhancing pixel charging rate and related display driving method.

2. Description of the Related Art

Flat panel displays (FPDs) have advantages of a thin profile, low power consumption, and low radiation, and are broadly adopted for application in a variety of electric appliances. In general, the flat panel display comprises a pixel array, a data driver, a scan driver, a plurality of data lines, and a plurality of scan lines. The data driver is utilized for providing plural data signals which are furnished to the pixel array via the data lines. The scan driver functions to generate plural scan signals which are furnished to the pixel array via the scan lines, such that the pixel array is able to perform pixel charging operation for illustrating images based on the data signals under control of the scan signals. However, as dimensions of the flat panel display increase, both trace resistance and parasitic capacitance of the scan and data lines increase, and transmission delay of the data and scan signals is therefore more serious than ever. For that reason, pixel charging rate of the flat panel display with greater dimensions is lower due to shorter effective charging time, which degrades display quality. Besides, regarding the flat panel display with high resolution, trace resistance of the scan and data lines increases following a decrease of line width, which also incurs low pixel charging rate. Finally, in the operation of the flat panel display, if the frame rate thereof is increased, the pixel charging rate is reduced due to shorter pixel charging time, thereby degrading display quality.

### SUMMARY

In accordance with an embodiment, a display apparatus capable of enhancing pixel charging rate is provided. The display apparatus comprises a substrate with an image display area, a first column transmission line, a second column transmission line, a first row transmission line, a first driver, and a second driver. The image display area includes a plurality of row wiring areas and a plurality of column wiring areas substantially particular to the row wiring areas. The row wiring areas and the column wiring areas are isolated by an insulation layer. The first column transmission line is disposed in an Mth column wiring area of the column wiring areas. The second column transmission line is disposed in the Mth column wiring area. The second column transmission line is electrically isolated form the first column transmission line. The first row transmission line is disposed in an Nth row wiring area of the row wiring areas. The first driver, electrically connected to the first column transmission line, is utilized for providing a first column driving signal furnished to the first column transmission line. The second driver, electrically connected to the second column transmission line, is utilized for providing a second column driving signal furnished to the second column transmission line.

The present invention further provides a display driving method for use in a display apparatus. The display apparatus comprises a substrate with an image display area, a first set of scan lines, a second set of scan lines, a plurality of first data lines, and a plurality of second data lines. The image display area includes a plurality of column wiring areas, a first set of row wiring areas substantially perpendicular to the row wiring areas, and a second set of row wiring areas substantially parallel to the first set of row wiring areas. The column wiring areas and the sets of row wiring areas are isolated by an insulation layer. The first set of scan lines is disposed in the first set of row wiring areas. The second set of scan lines, disposed in the second set of row wiring areas, is adjacent to the first set of scan lines. The first data lines are disposed in the column wiring areas respectively. Each of the first data lines is crossed with the first set of scan lines. The second data lines are disposed in the column wiring areas respectively. Each of the second data lines, crossed with the second set of scan lines, is electrically isolated from a corresponding first data line disposed in a same column wiring area. The display driving method comprises furnishing pulses of a first scan signal set sequentially triggered based on a sequence along a first direction to the first set of scan lines, and furnishing a first data signal set to the first data lines; and furnishing pulses of a second scan signal set sequentially triggered based on a sequence along a second direction to the second set of scan lines, and furnishing a second data signal set to the second data lines; wherein the pulses of the second scan signal set are in synchronization with the pulses of the first scan signal set.

The present invention further provides a display driving method for use in a display apparatus. The display apparatus comprises a substrate with an image display area, a first set of scan lines, a second set of scan lines, a third set of scan lines, a plurality of first data lines, a plurality of second data lines, and a plurality of third data lines. The image display area includes a plurality of column wiring areas, a first set of row wiring areas substantially perpendicular to the row wiring areas, a second set of row wiring areas substantially parallel to the first set of row wiring areas, and a third set of row wiring areas substantially parallel to the first set of row wiring areas. The column wiring areas and the sets of row wiring areas are isolated by an insulation layer. The first set of scan lines is disposed in the first set of row wiring areas. The second set of scan lines, disposed in the second set of row wiring areas, is adjacent to the first set of scan lines. The third set of scan lines, disposed in the third set of row wiring areas, is adjacent to the second set of scan lines. The first data lines are disposed in the column wiring areas respectively. Each of the first data lines is crossed with the first set of scan lines. The second data lines are disposed in the column wiring areas respectively. Each of the second data lines, crossed with the second set of scan lines, is electrically isolated from a corresponding first data line disposed in a same column wiring area. The third data lines are disposed in the column wiring areas respectively. Each of the third data lines, crossed with the third set of scan lines, is electrically isolated from corresponding first and second data lines disposed in a same column wiring area. The display driving method comprises furnishing pulses of a first scan signal set sequentially triggered based on a sequence along a first direction to the first set of scan lines, and furnishing a first data signal set to the first data lines; furnishing pulses of a second scan signal set sequentially triggered based on a sequence along a second direction to the second set of scan lines, and furnishing a second data signal set to the second data lines; and furnishing pulses of a third scan signal set sequentially triggered based on a sequence along a third direction to the third set of scan lines, and furnishing a third data signal set to the third data lines; wherein the pulses of the second and third scan signal sets are in synchronization with the pulses of the first scan signal set.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a display apparatus in accordance with a first embodiment.

FIG. 2 is a schematic diagram showing a display apparatus in accordance with a second embodiment.

FIG. 3 is a schematic diagram showing a display apparatus in accordance with a third embodiment.

FIG. 4 is a schematic diagram showing a display apparatus in accordance with a fourth embodiment.

FIG. 5 is a schematic diagram showing a display apparatus in accordance with a fifth embodiment.

FIG. 6 is a schematic diagram showing related signal waveforms regarding the operation of the display apparatus illustrated in FIG. 5 based on a first display driving method, having time along the abscissa.

FIG. 7 is a schematic diagram showing related signal waveforms regarding the operation of the display apparatus illustrated in FIG. 5 based on a second display driving method, having time along the abscissa.

FIG. 8 is a schematic diagram showing a display apparatus in accordance with a sixth embodiment.

FIG. 9 is a schematic diagram showing a display apparatus in accordance with a seventh embodiment.

### DETAILED DESCRIPTION

Hereinafter, some embodiments of the present invention will be described in detail with reference to the accompanying drawings. Here, it is to be noted that the present invention is not limited thereto.

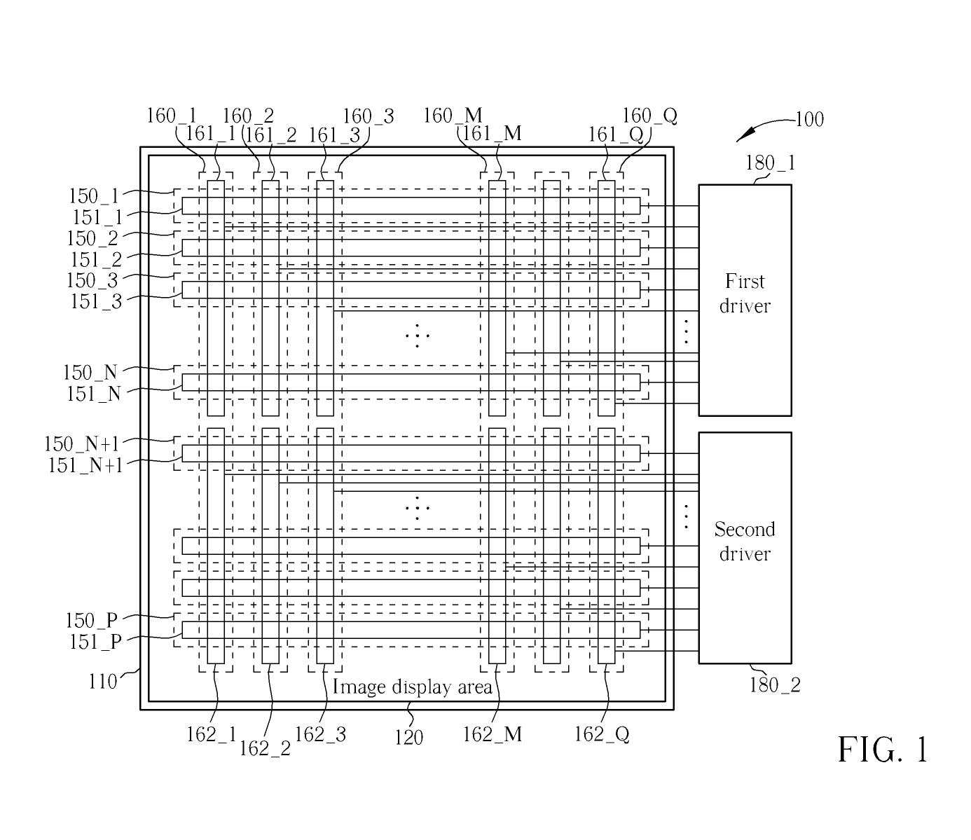

FIG. 1 is a schematic diagram showing a display apparatus in accordance with a first embodiment. As shown in FIG. 1, the display apparatus 100 comprises a first driver 180_1, a second driver 180_2, a substrate 110 having an image display area 120, a plurality of row transmission lines 151_1-151_P, and a plurality of column transmission lines 161_1-162_Q. In the embodiment shown in FIG. 1, the first driver 180_1 and the second driver 180_2 are disposed externally to the substrate 110. In another embodiment, the first driver 180_1 and the second driver 180_2 are disposed within the border area of the substrate 110. The image display area 120 includes a plurality of row wiring areas 150_1-150_P and a plurality of column wiring areas 160_1-160_Q substantially perpendicular to the row wiring areas 150_1-150_P. The row wiring areas 150_1-150_P and the column wiring areas 160_1-160_Q are isolated by an insulation layer. The row transmission lines 151_1-151_P are disposed in the row wiring areas 150_1-150_P respectively. The column transmission lines 161_1 and 162_1, electrically isolated from each other, are both disposed in the column wiring area 160_1. The column transmission lines 161_Q and 162_Q, electrically isolated from each other, are both disposed in the column wiring area 160_Q. The arrangement of other column transmission lines can be inferred by analogy. Each of the column transmission lines 161_1-161_Q is crossed with the row transmission lines 151_1-151_N. Each of the column transmission lines 162_1-162_Q is crossed with the row transmission lines 151_N+1-151_P.

The first driver 180_1 is utilized for providing a plurality of column driving signals respectively furnished to the column transmission lines 161_1-161_Q and providing a plurality of row driving signals respectively furnished to the row transmission lines 151_1-151_N. The second driver 180_2 is utilized for providing a plurality of column driving signals respectively furnished to the column transmission lines 162_1-162_Q and providing a plurality of row driving signals respectively furnished to the row transmission lines 151_N+1-151_P. It is noted that, in each of the embodiments aforementioned or to be mentioned, the row transmission lines and the column transmission lines may be scan lines and data lines respectively. Alternatively, the row transmission lines and the column transmission lines may be data lines and scan lines respectively. If the row transmission lines 151_1-151_P are scan lines, the row transmission lines 151_1 and 151_N+1 may be employed to transmit row driving signals having pulses synchronously or asynchronously triggered. If the column transmission lines 161_1-162_Q are scan lines, the column transmission lines 161_1 and 162_1 may be employed to transmit column driving signals having pulses synchronously or asynchronously triggered. Since the length of each of the column transmission lines 161_1-162_Q is substantially half that of prior-art column transmission line, the trace resistance and parasitic capacitance thereof are also respectively half the trace resistance and parasitic capacitance of prior-art column transmission line, which in turn significantly reduces the transmission delay of the column driving signals transmitted by the column transmission lines 161_1-162_Q for increasing pixel charging rate so as to enhance display quality.

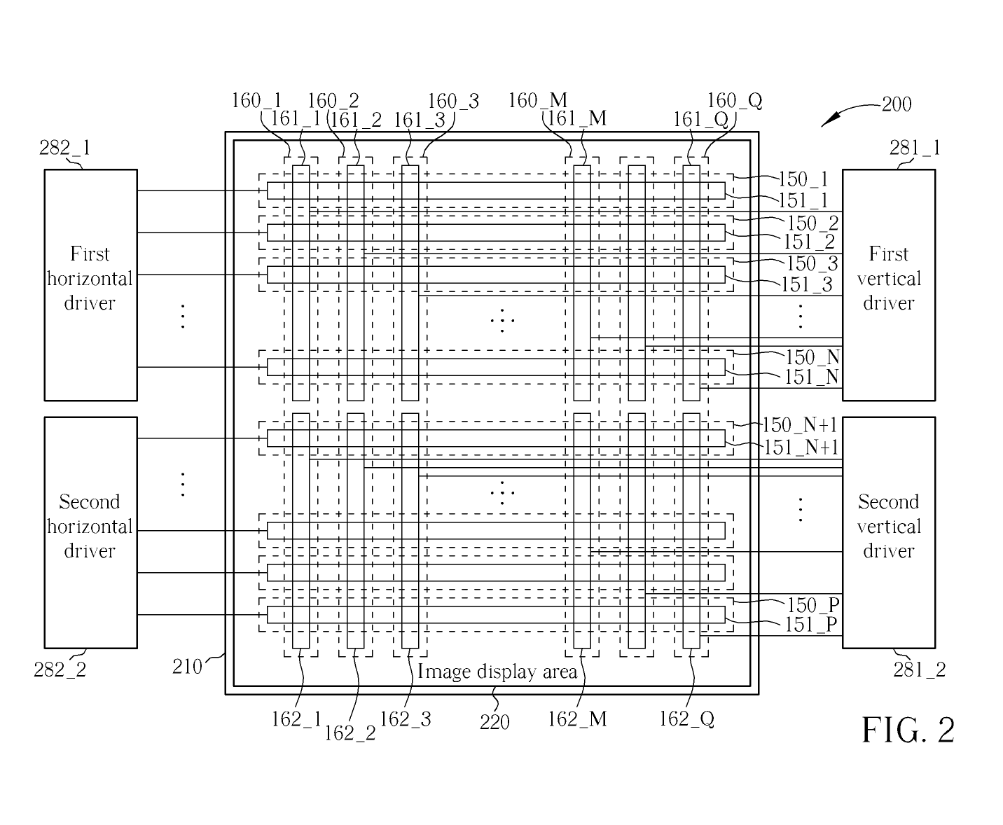

FIG. 2 is a schematic diagram showing a display apparatus in accordance with a second embodiment. As shown in FIG. 2, the display apparatus 200 comprises a first vertical driver 281_1, a second vertical driver 281_2, a first horizontal driver 282_1, a second horizontal driver 282_2, a substrate 210 having an image display area 220, the row transmission lines 151_1-151_P, and the column transmission lines 161_1-162_Q. The first vertical driver 281_1 and the second vertical driver 281_2 are arranged at a first side of the image display area 220. The first horizontal driver 282_1 and the second horizontal driver 282_2 are arranged at a second side of the image display area 220 which is opposite to the first side. The structure of the display apparatus 200 is similar to the display apparatus 100 illustrated in FIG. 1, differing in that the column transmission lines 161_1-161_Q are electrically connected to the first vertical driver 281_1 for receiving column driving signals, the column transmission lines 162_1-162_Q are electrically connected to the second vertical driver 281_2 for receiving column driving signals, the row transmission lines 151_1-151_N are electrically connected to the first horizontal driver 282_1 for receiving row driving signals, and the row transmission lines 151_N+1-151_P are electrically connected to the second horizontal driver 282_2 for receiving row driving signals. That is, each of the drivers shown in FIG. 2 is employed to provide either column driving signals or row driving signals.

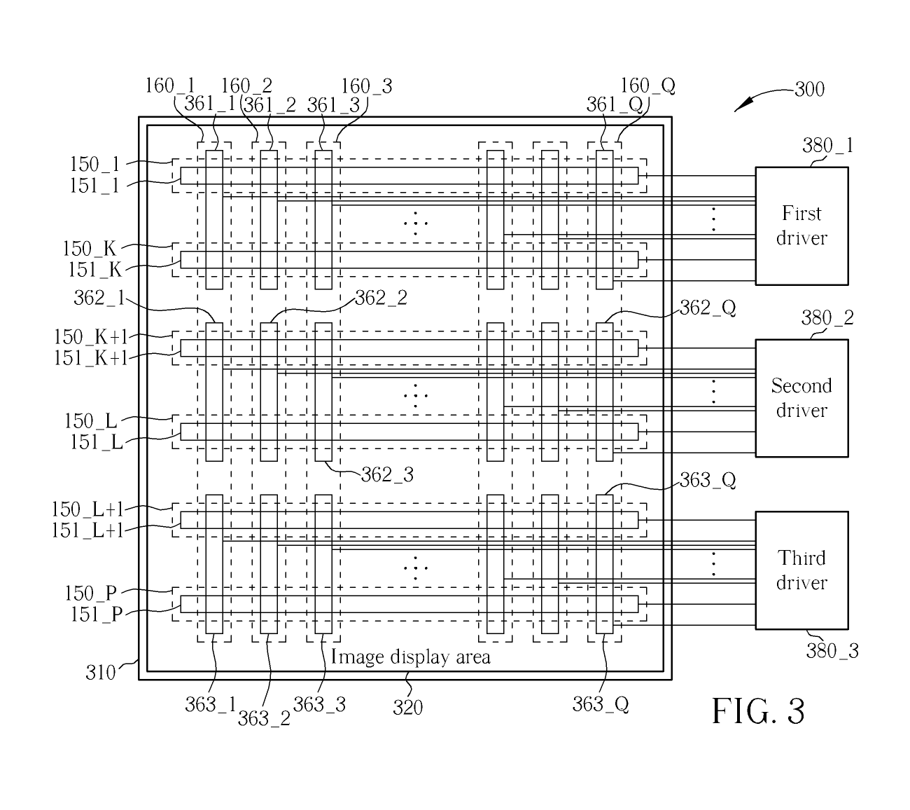

FIG. 3 is a schematic diagram showing a display apparatus in accordance with a third embodiment. As shown in FIG. 3, the display apparatus 300 comprises a first driver 380_1, a second driver 380_2, a third driver 380_3, a substrate 310 having an image display area 320, the row transmission lines 151_1-151_P, and a plurality of column transmission lines 361_1-363_Q. The structure of the display apparatus 300 is similar to the display apparatus 100 illustrated in FIG. 1, differing in that each of the column wiring areas 160_1-160_Q in the substrate 310 is employed to dispose three column transmission lines electrically isolated from each other. For instance, the column transmission lines 361_1, 362_1 and 363_1, electrically isolated from each other, are all disposed in the column wiring area 160_1. The column transmission lines 361_Q, 362_Q and 363_Q, electrically isolated from each other, are all disposed in the column wiring area 160_Q. And the arrangement of other column transmission lines can be inferred by analogy. The first driver 380_1 is utilized for providing a plurality of column driving signals respectively furnished to the column transmission lines 361_1-361_Q and providing a plurality of row driving signals respectively furnished to the row transmission lines 151_1-151_K. The second driver 380_2 is utilized for providing a plurality of column driving signals respectively furnished to the column transmission lines 362_1-362_Q and providing a plurality of row driving signals respectively furnished to the row transmission lines 151_K+1-151_L. The third driver 380_3 is utilized for providing a plurality of column driving signals respectively furnished to the column transmission lines 363_1-363_Q and providing a plurality of row driving signals respectively furnished to the row transmission lines 151_L+1-151_P.

Since the length of each of the column transmission lines 361_1-363_Q is substantially one-third that of prior-art column transmission line, the trace resistance and parasitic capacitance thereof are also respectively one-third the trace resistance and parasitic capacitance of prior-art column transmission line, which in turn significantly reduces the transmission delay of the column driving signals transmitted by the column transmission lines 361_1-363_Q for increasing pixel charging rate so as to enhance display quality. It is noted that, in the architecture of the display apparatus according to the present invention, each column wiring area of the substrate is not limited to dispose the aforementioned two or three column transmission lines electrically isolated from each other, and may be employed to dispose more column transmission lines electrically isolated from each other.

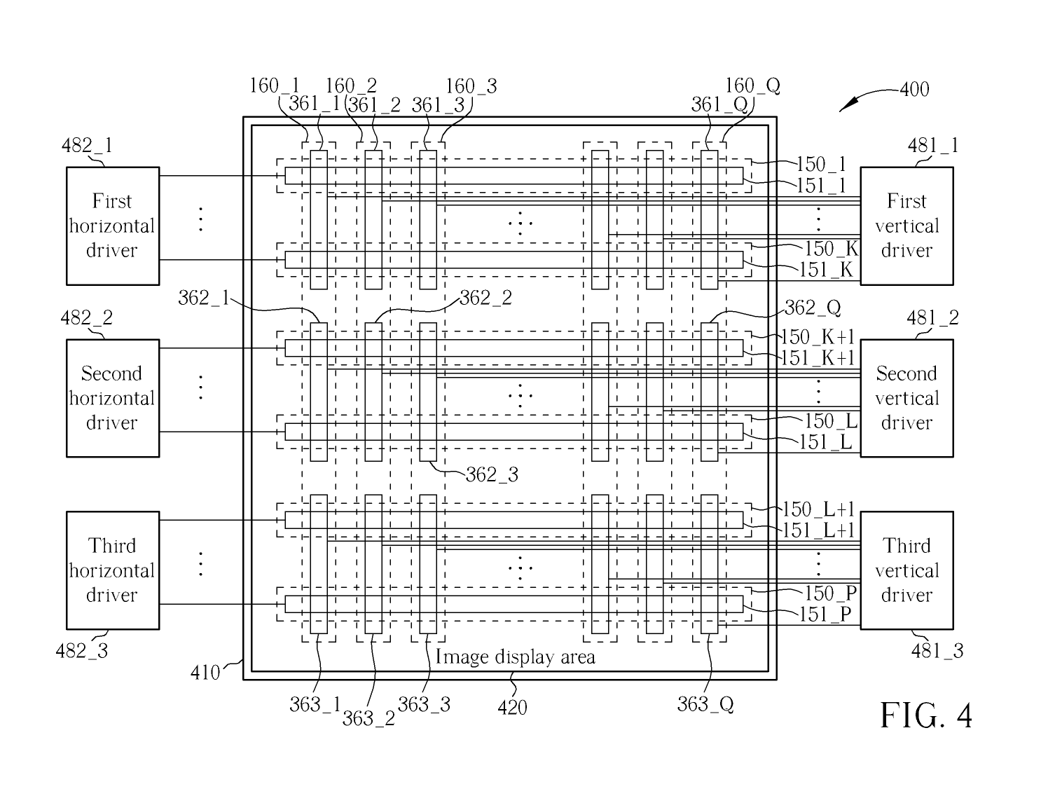

FIG. 4 is a schematic diagram showing a display apparatus in accordance with a fourth embodiment. As shown in FIG. 4, the display apparatus 400 comprises a first vertical driver 481_1, a second vertical driver 481_2, a third vertical driver 481_3, a first horizontal driver 482_1, a second horizontal driver 482_2, a third horizontal driver 482_3, a substrate 410 having an image display area 420, the row transmission lines 151_1-151_P, and the column transmission lines 361_1-363_Q. The first vertical driver 481_1, the second vertical driver 481_2 and the third vertical driver 481_3 are arranged at a first side of the image display area 420. The first horizontal driver 482_1, the second horizontal driver 482_2 and the third horizontal driver 482_3 are arranged at a second side of the image display area 420 which is opposite to the first side. The structure of the display apparatus 400 is similar to the display apparatus 300 illustrated in FIG. 3, differing in that the column transmission lines 361_1-361_Q are electrically connected to the first vertical driver 481_1 for receiving column driving signals, the column transmission lines 362_1-362_Q are electrically connected to the second vertical driver 481_2 for receiving column driving signals, the column transmission lines 363_1-363_Q are electrically connected to the third vertical driver 481_3 for receiving column driving signals, the row transmission lines 151_1-151_K are electrically connected to the first horizontal driver 482_1 for receiving row driving signals, the row transmission lines 151_K+1-151_L are electrically connected to the second horizontal driver 482_2 for receiving row driving signals, and the row transmission lines 151_L+1-151_P are electrically connected to the third horizontal driver 482_3 for receiving row driving signals. That is, each of the drivers shown in FIG. 4 is employed to provide either column driving signals or row driving signals.

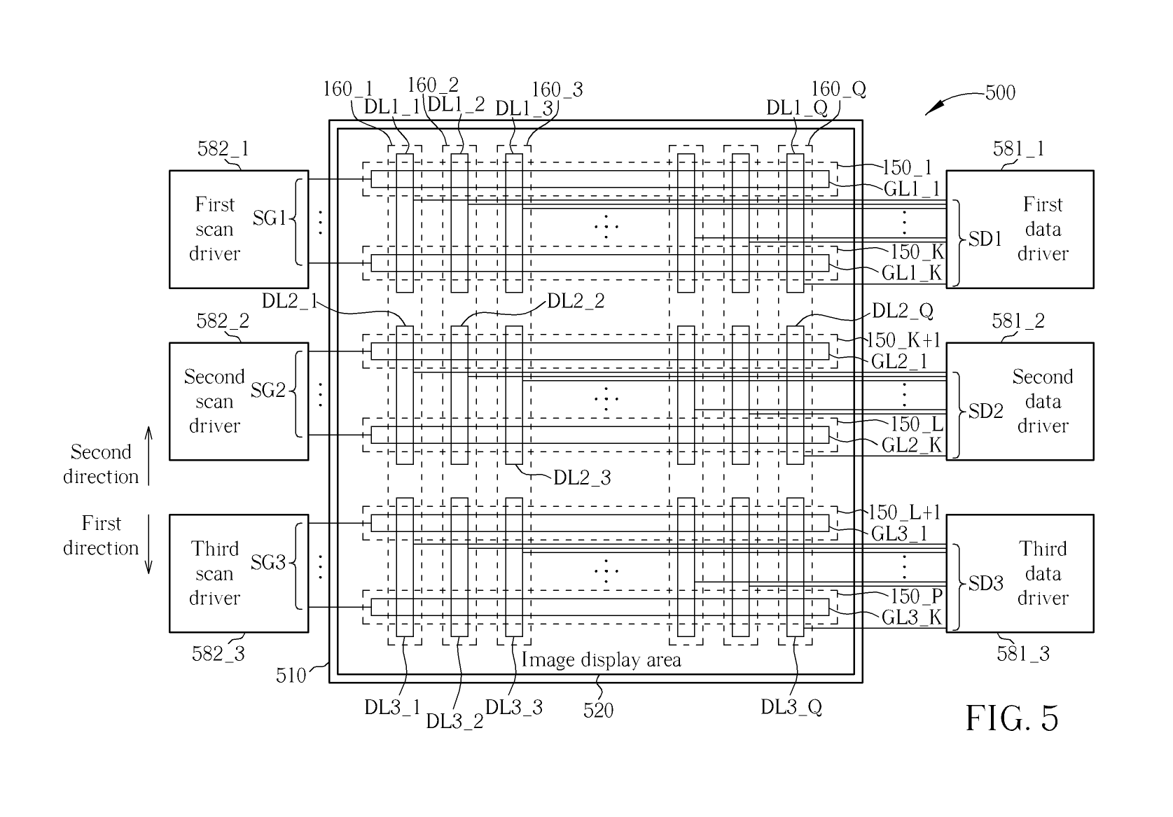

FIG. 5 is a schematic diagram showing a display apparatus in accordance with a fifth embodiment. As shown in FIG. 5, the display apparatus 500 comprises a first data driver 581_1, a second data driver 581_2, a third data driver 581_3, a first scan driver 582_1, a second scan driver 582_2, a third scan driver 582_3, a substrate 510 having an image display area 520, a plurality of scan lines GL1_1-GL3_K, and a plurality of data lines DL1_1-DL3_Q. The first data driver 581_1, the second data driver 581_2 and the third data driver 581_3 are arranged at a first side of the image display area 520. The first scan driver 582_1, the second scan driver 582_2 and the third scan driver 582_3 are arranged at a second side of the image display area 520 which is opposite to the first side.

The scan lines GL1_1-GL1_K are respectively disposed in the row wiring areas 150_1-150_K, the scan lines GL2_1-GL2_K are respectively disposed in the row wiring areas 150_K+1-150_L, and the scan lines GL3_1-GL3_K are respectively disposed in the row wiring areas 150_L+1-150_P, i.e. L equals 2K and P equals 3K. The scan lines GL1_1-GL1_K are employed to transmit the scan signals SG1_1-SG1_K of a first scan signal set SG1, the scan lines GL2_1-GL2_K are employed to transmit the scan signals SG2_1-SG2_K of a second scan signal set SG2, and the scan lines GL3_1-GL3_K are employed to transmit the scan signals SG3_1-SG3_K of a third scan signal set SG3. The data lines DL1_1, DL2_1 and DL3_1, electrically isolated from each other, are all disposed in the column wiring area 160_1. The data lines DL1_Q, DL2_Q and DL3_Q, electrically isolated from each other, are all disposed in the column wiring area 160_Q. The arrangement of other data lines can be inferred by analogy.

The first data driver 581_1 is utilized for providing a first data signal set SD1 furnished to the data lines DL1_1-DL1_Q, the second data driver 581_2 is utilized for providing a second data signal set SD2 furnished to the data lines DL2_1-DL2_Q, and the third data driver 581_3 is utilized for providing a third data signal set SD3 furnished to the data lines DL3_1-DL3_Q. The first scan driver 582_1 is utilized for providing the first scan signal set SG1 furnished to the scan lines GL1_1-GL1_K, the second scan driver 582_2 is utilized for providing the second scan signal set SG2 furnished to the scan lines GL2_1-GL2_K, and the third scan driver 582_3 is utilized for providing the third scan signal set SG3 furnished to the scan lines GL3_1-GL3_K.

The first scan driver 582_1 may sequentially trigger the pulses of the first scan signal set SG1 based on a sequence along a first direction or a second direction opposite to the first direction as shown in FIG. 5. The second scan driver 582_2 may sequentially trigger the pulses of the second scan signal set SG2 based on a sequence along the first or second direction. Also, the third scan driver 582_3 may sequentially trigger the pulses of the third scan signal set SG3 based on a sequence along the first or second direction.

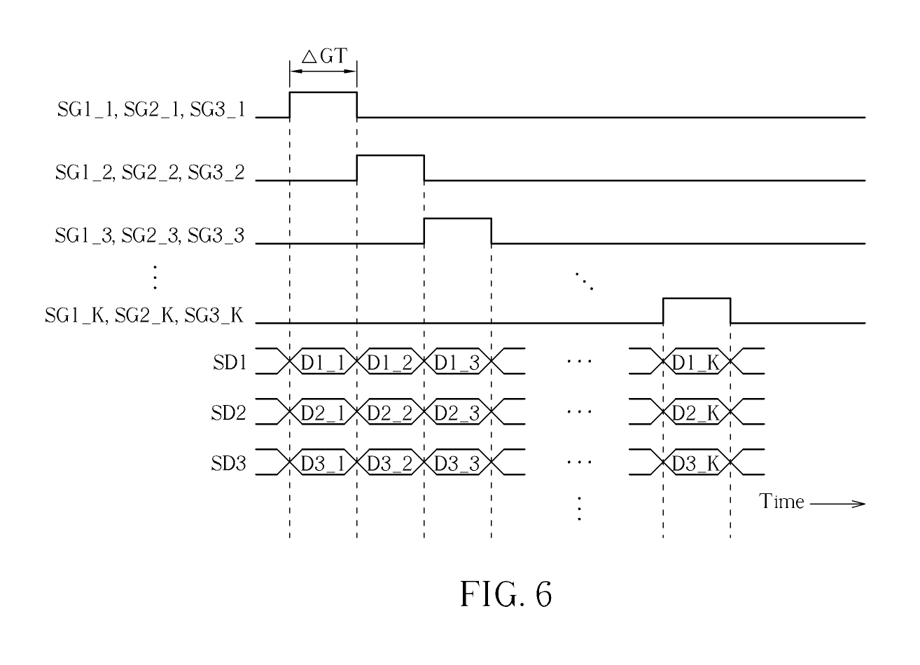

FIG. 6 is a schematic diagram showing related signal waveforms regarding the operation of the display apparatus 500 illustrated in FIG. 5 based on a first display driving method, having time along the abscissa. The signal waveforms in FIG. 6, from top to bottom, are the scan signal SG1_1 (SG2_1, SG3_1), the scan signal SG1_2 (SG2_2, SG3_2), the scan signal SG1_3 (SG2_3, SG3_3), . . . , the scan signal SG1_K (SG2_K, SG3_K), the first data signal set SD1, the second data signal set SD2, and the third data signal set SD3. Referring to FIG. 6 in conjunction with FIG. 5 for demonstrating the first display driving method, the first scan driver 582_1 is employed to sequentially trigger the pulses of the first scan signal set SG1 based on a sequence along the first direction, the second scan driver 582_2 is employed to sequentially trigger the pulses of the second scan signal set SG2 based on a sequence along the first direction, and the third scan driver 582_3 is employed to sequentially trigger the pulses of the third scan signal set SG3 based on a sequence also along the first direction. Accordingly, the pulses of the scan signals SG1_X, SG2_X and SG3_X are triggered in synchronization, such that the data signals D1_X-D3_X can be written synchronously, wherein X is an integer between 1 and K. That is, the data signals corresponding to three rows of pixels are written simultaneously during each scan pulse interval ΔGT. For that reason, the pixel charging rate of the display apparatus 500 based on the first display driving method may be significantly boosted by extending the pixel charging time to be three times the length of prior-art pixel charging time, for enhancing display quality.

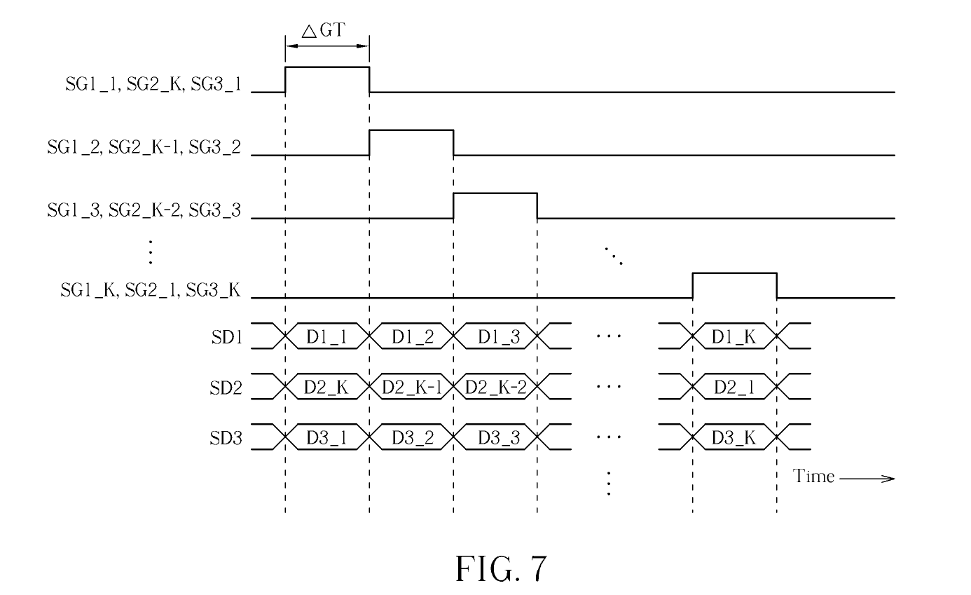

FIG. 7 is a schematic diagram showing related signal waveforms regarding the operation of the display apparatus 500 illustrated in FIG. 5 based on a second display driving method, having time along the abscissa. The signal waveforms in FIG. 7, from top to bottom, are the scan signal SG1_1 (SG2_K, SG3_1), the scan signal SG1_2 (SG2_K−1, SG3_2), the scan signal SG1_3 (SG2_K−2, SG3_3), . . . , the scan signal SG1_K (SG2_1, SG3_K), the first data signal set SD1, the second data signal set SD2, and the third data signal set SD3. Referring to in FIG. 7 in conjunction with FIG. 5 for demonstrating the second display driving method, the first scan driver 582_1 is employed to sequentially trigger the pulses of the first scan signal set SG1 based on a sequence along the first direction, the second scan driver 582_2 is employed to sequentially trigger the pulses of the second scan signal set SG2 based on a sequence along the second direction, and the third scan driver 582_3 is employed to sequentially trigger the pulses of the third scan signal set SG3 based on a sequence along the first direction. Accordingly, the pulses of the scan signals SG1_Y, SG2_K−Y+1 and SG3_Y are triggered in synchronization, such that the data signals D1_Y, D2_K−Y+1 and D3_Y can be written synchronously, wherein Y is an integer between 1 and K. Similarly, the data signals corresponding to three rows of pixels are written simultaneously during each scan pulse interval ΔGT, such that the pixel charging rate of the display apparatus 500 based on the second display driving method can be significantly boosted by extending the pixel charging time, for enhancing display quality. Besides, since the pulse triggering sequence of the second scan signal set SG2 is opposite to that of the first scan signal set SG1 and the third scan signal set SG3, the mura effect on the screen of the display apparatus 500 using the second display driving method is significantly reduced for further enhancing display quality.

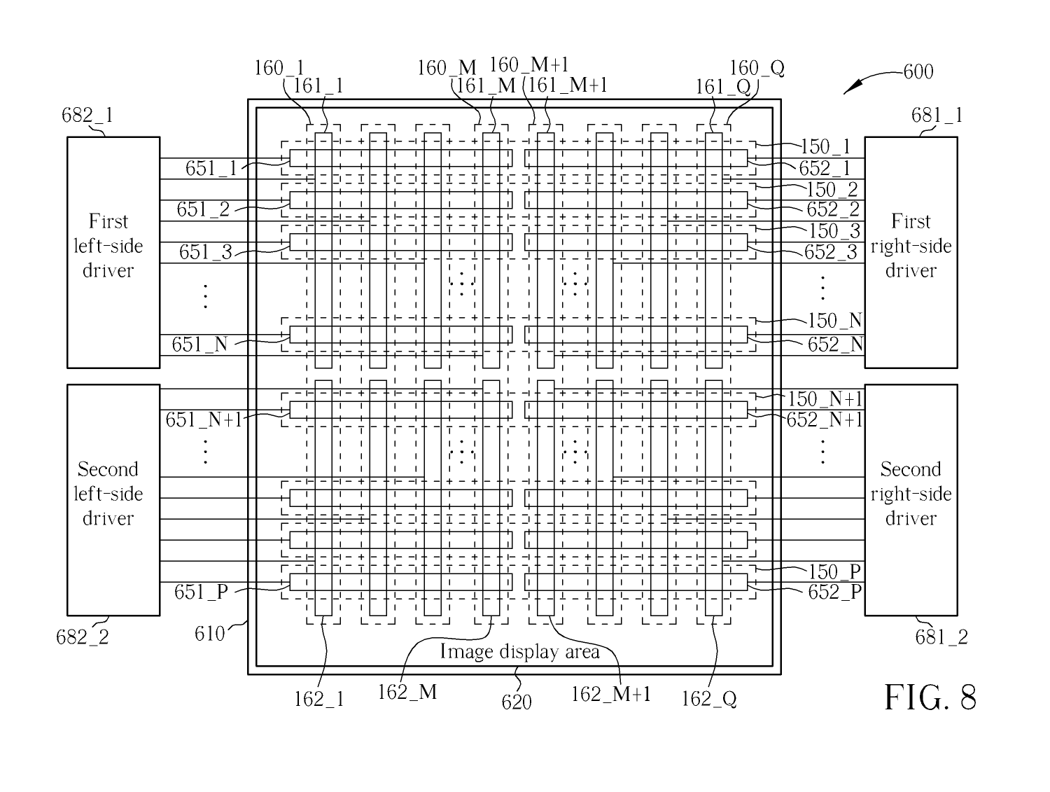

FIG. 8 is a schematic diagram showing a display apparatus in accordance with a sixth embodiment. As shown in FIG. 8, the display apparatus 600 comprises a first right-side driver 681_1, a second right-side driver 681_2, a first left-side driver 682_1, a second left-side driver 682_2, a substrate 610 having an image display area 620, a plurality of row transmission lines 651_1-652_P, and the column transmission lines 161_1-162_Q. The first right-side driver 681_1 and the second right-side driver 681_2 are arranged at the right side of the image display area 620. The first left-side driver 682_1 and the second left-side driver 682_2 are arranged at the left side of the image display area 620. The structure of the display apparatus 600 is similar to the display apparatus 100 illustrated in FIG. 1, differing in that each of the row wiring areas 150_1-150_P in the substrate 610 is employed to dispose two row transmission lines electrically isolated from each other. For instance, the row transmission lines 651_1 and 652_1, electrically isolated from each other, are both disposed in the row wiring area 150_1. The row transmission lines 651_P and 652_P, electrically isolated from each other, are both disposed in the row wiring area 150_P. And the arrangement of other row transmission lines can be inferred by analogy. Besides, if the row transmission lines 651_1-652_P are scan lines, the row transmission lines 651_1 and 652_1 maybe employed to transmit row driving signals having pulses synchronously or asynchronously triggered.

The first left-side driver 682_1 is utilized for providing a plurality of column driving signals respectively furnished to the column transmission lines 161_1-161_M and providing a plurality of row driving signals respectively furnished to the row transmission lines 651_1-651_N. The second left-side driver 682_2 is utilized for providing a plurality of column driving signals respectively furnished to the column transmission lines 162_1-162_M and providing a plurality of row driving signals respectively furnished to the row transmission lines 651_N+1-651_P. The first right-side driver 681_1 is utilized for providing a plurality of column driving signals respectively furnished to the column transmission lines 161_M+1-161_Q and providing a plurality of row driving signals respectively furnished to the row transmission lines 652_1-652_N. The second right-side driver 681_2 is utilized for providing a plurality of column driving signals respectively furnished to the column transmission lines 162_M+1-162_Q and providing a plurality of row driving signals respectively furnished to the row transmission lines 652_N+1-652_P. That is, in the structure of the display apparatus 600, the length of each of the column transmission lines 161_1-162_Q is substantially half that of prior-art column transmission line, and the length of each of the row transmission lines 651_1-652_P is also substantially half that of prior-art row transmission line, which in turn significantly reduces the transmission delay of both the column and row driving signals for greatly increasing pixel charging rate so as to enhance display quality.

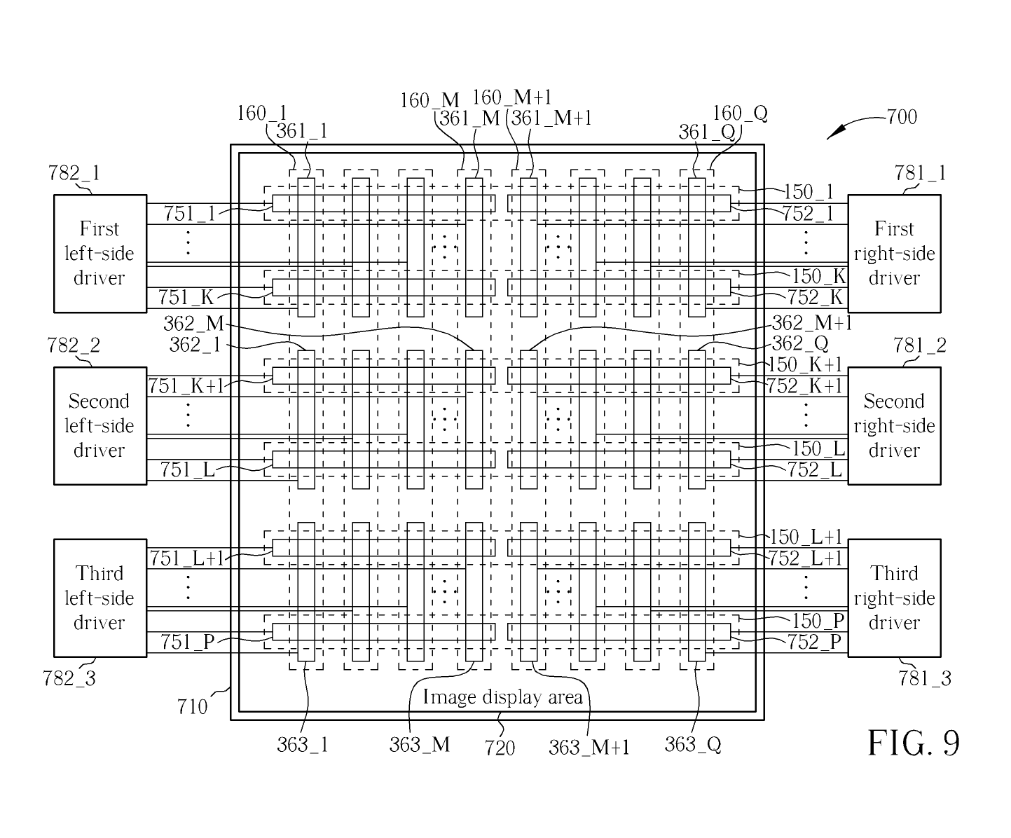

FIG. 9 is a schematic diagram showing a display apparatus in accordance with a seventh embodiment. As shown in FIG. 9, the display apparatus 700 comprises a first right-side driver 781_1, a second right-side driver 781_2, a third right-side driver 781_3, a first left-side driver 782_1, a second left-side driver 782_2, a third left-side driver 782_3, a substrate 710 having an image display area 720, a plurality of row transmission lines 751_1-752_P, and the column transmission lines 361_1-363_Q. The first right-side driver 781_1, the second right-side driver 781_2 and the third right-side driver 781_3 are arranged at the right side of the image display area 720. The first left-side driver 782_1, the second left-side driver 782_2 and the third left-side driver 782_3 are arranged at the left side of the image display area 720. The structure of the display apparatus 700 is similar to the display apparatus 300 illustrated in FIG. 3, differing in that each of the row wiring areas 150_1-150_P in the substrate 710 is employed to dispose two row transmission lines electrically isolated from each other. For instance, the row transmission lines 751_1 and 752_1, electrically isolated from each other, are both disposed in the row wiring area 150_1. The row transmission lines 751_P and 752_P, electrically isolated from each other, are both disposed in the row wiring area 150_P. And the arrangement of other row transmission lines can be inferred by analogy. Besides, if the row transmission lines 751_1-752_P are scan lines, the row transmission lines 751_1 and 752_1 maybe employed to transmit row driving signals having pulses synchronously or asynchronously triggered.

The first left-side driver 782_1 is utilized for providing a plurality of column driving signals respectively furnished to the column transmission lines 361_1-361_M and providing a plurality of row driving signals respectively furnished to the row transmission lines 751_1-751_K. The second left-side driver 782_2 is utilized for providing a plurality of column driving signals respectively furnished to the column transmission lines 362_1-362_M and providing a plurality of row driving signals respectively furnished to the row transmission lines 751_K+1-751_L. The third left-side driver 782_3 is utilized for providing a plurality of column driving signals respectively furnished to the column transmission lines 363_1-363_M and providing a plurality of row driving signals respectively furnished to the row transmission lines 751_L+1-751_P. The first right-side driver 781_1 is utilized for providing a plurality of column driving signals respectively furnished to the column transmission lines 361_M+1-361_Q and providing a plurality of row driving signals respectively furnished to the row transmission lines 752_1-752_K. The second right-side driver 781_2 is utilized for providing a plurality of column driving signals respectively furnished to the column transmission lines 362_M+1-362_Q and providing a plurality of row driving signals respectively furnished to the row transmission lines 752_K+1-752_L. The third right-side driver 781_3 is utilized for providing a plurality of column driving signals respectively furnished to the column transmission lines 363_M+1-363_Q and providing a plurality of row driving signals respectively furnished to the row transmission lines 752_L+1-752_P. That is, in the structure of the display apparatus 700, the length of each of the column transmission lines 361_1-363_Q is substantially one-third that of prior-art column transmission line, and the length of each of the row transmission lines 751_1-752_P is substantially half that of prior-art row transmission line, which in turn significantly reduces the transmission delay of both the column and row driving signals for greatly increasing pixel charging rate so as to enhance display quality.

To sum up, in the structure of the display apparatus according to the present invention, each column wiring area is employed to dispose at least two column transmission lines electrically isolated from each other, and/or each row wiring area is employed to dispose at least two row transmission lines electrically isolated from each other, such that the transmission delay of column driving signals and/or row driving signals can be significantly reduced for increasing pixel charging rate so as to enhance display quality. Besides, in the operation of the display apparatus according to the present invention, by means of synchronously triggering pulses of plural scan signals, each scan pulse interval can be extended correspondingly so as to further increase pixel charging rate for enhancing display quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display apparatus comprising:
a substrate with an image display area, the image display area having a plurality of row wiring areas and a plurality of column wiring areas substantially particular to the row wiring areas, wherein the row wiring areas and the column wiring areas are isolated by an insulation layer;
a first column transmission line disposed in an Mth column wiring area of the column wiring areas;
a second column transmission line disposed in the Mth column wiring area, the second column transmission line being electrically isolated form the first column transmission line;
a first row transmission line disposed in an Nth row wiring area of the row wiring areas;
a first driver, electrically connected to the first column transmission line, for providing a first column driving signal furnished to the first column transmission line; and
a second driver, electrically connected to the second column transmission line, for providing a second column driving signal furnished to the second column transmission line.

2. The display apparatus of claim 1, further comprising:
a third driver, electrically connected to the first row transmission line, for providing a first row driving signal furnished to the first row transmission line;
wherein the first driver and the second driver are disposed at a first side of the image display area, and the third driver is disposed at a second side of the image display area which is opposite to the first side.

3. The display apparatus of claim 1, wherein the first driver is further employed to provide a first row driving signal furnished to the first row transmission line.

4. The display apparatus of claim 3, further comprising:
a second row transmission line, disposed in the Nth row wiring area, the second row transmission line being electrically isolated from the first row transmission line; and
a third driver, electrically connected to the second row transmission line, for providing a second row driving signal furnished to the second row transmission line.

5. The display apparatus of claim 4, wherein the first driver and the second driver are disposed at a first side of the image display area, and the third driver is disposed at a second side of the image display area which is opposite to the first side.

6. The display apparatus of claim 4, wherein the column transmission lines are scan lines and the row transmission lines are data lines.

7. The display apparatus of claim 6, wherein a pulse of the second column driving signal is synchronous or asynchronous with a pulse of the first column driving signal.

8. The display apparatus of claim 1, wherein the column transmission lines are data lines and the row transmission line is a scan line.

9. The display apparatus of claim 1, further comprising:
a third column transmission line, disposed in the Mth column wiring area, the third column transmission line being electrically isolated from the first and second column transmission lines; and
a third driver, electrically connected to the third column transmission line, for providing a third column driving signal furnished to the third column transmission line.

10. The display apparatus of claim 9, wherein the first driver, the second driver and the third driver are disposed at a same side of the image display area.

11. The display apparatus of claim 1, further comprising:
a second row transmission line, disposed in a Jth row wiring area of the row wiring area, the Jth row wiring area being different from the Nth row wiring area;
a third driver, electrically connected to the first row transmission line, for providing a first row driving signal furnished to the first row transmission line; and
a fourth driver, electrically connected to the second row transmission line, for providing a second row driving signal furnished to the second row transmission line.

12. The display apparatus of claim 11, wherein the first driver and the second driver are disposed at a first side of the image display area, and the third driver and the fourth driver are disposed at a second side of the image display area which is opposite to the first side.

13. The display apparatus of claim 11, wherein the column transmission lines are scan lines and the row transmission lines are data lines.

14. The display apparatus of claim 13, wherein a pulse of the second column driving signal is synchronous or asynchronous with a pulse of the first column driving signal.

15. The display apparatus of claim 11, wherein the column transmission lines are data lines and the row transmission lines are scan lines.

16. The display apparatus of claim 15, wherein a pulse of the second row driving signal is synchronous or asynchronous with a pulse of the first row driving signal.

17. A display driving method comprising:
providing a display apparatus, the display apparatus comprising:
a substrate with an image display area, the image display area having a plurality of column wiring areas, a first set of row wiring areas substantially perpendicular to the column wiring areas, and a second set of row wiring areas substantially parallel to the first set of row wiring areas, wherein the column wiring areas and the sets of row wiring areas are isolated by an insulation layer;
a first set of scan lines disposed in the first set of row wiring areas;
a second set of scan lines, disposed in the second set of row wiring areas, the second set of scan lines being adjacent to the first set of scan lines;
a plurality of first data lines, disposed in the column wiring areas, each of the first data lines being crossed with the first set of scan lines; and
a plurality of second data lines, disposed in the column wiring areas, each of the second data lines being crossed with the second set of scan lines and electrically isolated from a corresponding first data line disposed in a same column wiring area;
furnishing pulses of a first scan signal set sequentially triggered based on a sequence along a first direction to the first set of scan lines, and furnishing a first data signal set to the first data lines; and
furnishing pulses of a second scan signal set sequentially triggered based on a sequence along a second direction to the second set of scan lines, and furnishing a second data signal set to the second data lines;
wherein the pulses of the second scan signal set are in synchronization with the pulses of the first scan signal set.

18. The display driving method of claim 17, wherein the second direction is identical to the first direction.

19. The display driving method of claim 17, wherein the second direction is opposite to the first direction.

20. A display driving method comprising:
providing a display apparatus, the display apparatus comprising:
a substrate with an image display area, the image display area having a plurality of column wiring areas, a first set of row wiring areas substantially perpendicular to the column wiring areas, a second set of row wiring areas substantially parallel to the first set of row wiring areas, and a third set of row wiring areas substantially parallel to the first set of row wiring areas, wherein the column wiring areas and the sets of row wiring areas are isolated by an insulation layer;
a first set of scan lines disposed in the first set of row wiring areas;
a second set of scan lines, disposed in the second set of row wiring areas, the second set of scan lines being adjacent to the first set of scan lines;
a third set of scan lines, disposed in the third set of row wiring areas, the third set of scan lines being adjacent to the second set of scan lines;
a plurality of first data lines, disposed in the column wiring areas, each of the first data lines being crossed with the first set of scan lines;
a plurality of second data lines, disposed in the column wiring areas, each of the second data lines being crossed with the second set of scan lines and electrically isolated from a corresponding first data line disposed in a same column wiring area; and
a plurality of third data lines, disposed in the column wiring areas, each of the third data lines being crossed with the third set of scan lines and electrically isolated from corresponding first and second data lines disposed in a same column wiring area;
furnishing pulses of a first scan signal set sequentially triggered based on a sequence along a first direction to the first set of scan lines, and furnishing a first data signal set to the first data lines;
furnishing pulses of a second scan signal set sequentially triggered based on a sequence along a second direction to the second set of scan lines, and furnishing a second data signal set to the second data lines; and
furnishing pulses of a third scan signal set sequentially triggered based on a sequence along a third direction to the third set of scan lines, and furnishing a third data signal set to the third data lines;
wherein the pulses of the second scan signal sets are in synchronization with the pulses of the first scan signal set, and the pulses of the third scan signal sets are in synchronization with the pulses of the first scan signal set.

21. The display driving method of claim 20, wherein the second direction is identical to the first direction and the third direction is identical to the first direction.

22. The display driving method of claim 20, wherein the second direction is opposite to the first direction and the third direction is identical to the first direction.
